(19) United States
(12) Patent Application Publication
(10) Pub. No.: US 2025/0206905 A1
(43) Pub. Date: Jun. 26, 2025

(54) RECYCLING METHOD OF POLYESTER MATERIAL

(71) Applicant: NAN YA PLASTICS CORPORATION, Taipei City (TW)

(72) Inventors: Te-Chao Liao, Taipei City (TW); Chung Yu Chen, Taipei City (TW); Zhang-Jian Huang, Taipei City (TW); Mong-Chen Chang, Taipei City (TW)

(73) Assignee: NAN YA PLASTICS CORPORATION, Taipei City (TW)

(21) Appl. No.: 18/412,638

(22) Filed: Jan. 15, 2024

(30) Foreign Application Priority Data
Dec. 21, 2023 (TW) 112150075

(51) Int. Cl. C08J 11/12

(52) U.S. Cl. CPC C08J 11/12; C08J 2367/03

(57) ABSTRACT

The disclosure provides a recycling method of a polyester material, which includes the following steps. First, the polyester material is subdivided and washed, and then dried using a microwave drying process. Afterwards, the dried polyester material is melted and extruded, and a flow direction of the molten polyester material is at a tangential angle to a surface of a filter for performing melt filtration. Next, the filtered polyester material is cooled and pelletized.

### CROSS-REFERENCE TO RELATED APPLICATION

This application claims the priority benefit of Taiwan application serial no. 112150075, filed on Dec. 21, 2023. The entirety of the above-mentioned patent application is hereby incorporated by reference herein and made a part of this specification.

### BACKGROUND

### Technical Field

The disclosure relates to a recycling method of a material, and in particular, relates to a recycling method of a polyester material.

### Description of Related Art

In the mechanical recycling method of a waste polyester (polyethylene terephthalate, PET for short), the conventional technology is to subdivide (breaking PET bottles and film products into pieces, cutting fabrics into shreds, etc.), wash, dry, melt and extrude the waste PET to then undergo processes such as melt filtration and granulation so as to obtain the recycled PET (r-PET).

In the mechanical recycling process of the PET, the drying and filtration processes are very important, and involve quality, including hue, impurity content, intrinsic viscosity (IV), etc., as well as process efficiency (capacity, pressure loss). The conventional technology is to use hot air drying and static filters to filter impurities. However, the use of hot air to dry the waste PET has limitations since shreds or fragments are easy to stick and agglomerate, and some PET has residual moisture, and the PET with the residual moisture will cause degradation (lowering of IV) and poor hue when extruded at high temperatures. When a static mechanism to filter the impurities is used, the flow direction of the molten PET is perpendicular to the surface of the filter such that impurities (solids) can easily get stuck in the hole of the filter, causing pressure to rise and thereby deforming or disintegrating the filter hole. The impurities cannot be filtered out and affect the quality, thereby affecting subsequent processability. Based on the above two shortcomings, subsequent processability will be affected. In particular, when processing into PET bottles, the IV is insufficient, impurities remain, and the hue is too yellow. Spinning is also prone to filament breakage due to residual impurities, thereby affecting the spinning process.

Based on the above, it is an important topic currently required for research to develop a recycling method of a polyester material to improve subsequent processability.

### SUMMARY

The disclosure provides a recycling method of a polyester material, which can improve subsequent processability and improve quality and process efficiency of a recycled PET.

A recycling method of a polyester material of the disclosure includes the following steps. First, the polyester material is subdivided and washed, and then dried using a microwave drying process. Afterwards, the dried polyester material is melted and extruded, and a flow direction of the molten polyester material is at a tangential angle to a surface of a filter for performing melt filtration. Next, the molten and filtered polyester material is cooled and pelletized.

In an embodiment of the disclosure, after being subdivided and washed, the polyester material is first dried using a hot air drying process, and then dried using the microwave drying process.

In an embodiment of the disclosure, a drying temperature of the hot air drying process is 40° C. to 150° C., a drying time is 5 minutes to 80 minutes, and a wind speed is 1 m/s to 50 m/s.

In an embodiment of the disclosure, a size of the polyester material after subdivision is less than 5×5 cm².

In an embodiment of the disclosure, a drying temperature of the microwave drying process is 30° C. to 125° C., a drying time is 0.1 minutes to 5 minutes, and a microwave power is 1 kw to 100 kw.

In an embodiment of the disclosure, a moisture content of the polyester material after being dried by the microwave drying process is less than 1,000 ppm (0.1%).

In an embodiment of the disclosure, a temperature for performing melt extrusion is 220° C. to 300° C.

In an embodiment of the disclosure, a temperature for performing melt filtration is 230° C. to 290° C.

In an embodiment of the disclosure, an aperture of a filter hole of the filter is 10 μm to 100 μm.

In an embodiment of the disclosure, a tangential speed of a flow of the molten polyester material and the filter hole of the filter is 10 m/min to 200 m/min.

In an embodiment of the disclosure, a pressure for performing filtration is 10 bar to 100 bar.

In an embodiment of the disclosure, the filtered polyester material is cooled to a temperature of 30° C. to 90° C.

In an embodiment of the disclosure, an intrinsic viscosity (IV) of the recycled polyester material is 0.45 dl/g to 1.30 dl/g, and a decrease in intrinsic viscosity (IV) is less than 0.06 dl/g.

In an embodiment of the disclosure, the filter is mesh woven or laser drilled.

In an embodiment of the disclosure, the flow direction of the polyester material is at the tangential angle to the surface of the filter. The filter is fixed such that the flow of the polyester material flows through a side, and the flow of the polyester material is in tangential contact with the filter.

In an embodiment of the disclosure, the flow direction of the polyester material is at the tangential angle to the surface of the filter, and the filter adopts a rotating method to bring the flow of the polyester material into tangential contact with the filter.

In an embodiment of the disclosure, a speed of the flow of the polyester material flowing through the filter hole of the filter is 0.1 m/min to 10 m/min.

Based on the above, the disclosure provides the recycling method of the polyester material. The use of a penetrating and targeted microwave drying process can improve the uniformity of drying and allow the moisture to be evenly reduced to the specification requirements, so that there will be no partial parts that are undried. In addition, the recycling method of the polyester material of the disclosure also uses a dynamic melt filtration mechanism to make the PET flow direction contact with the surface of the filter at the tangential angle and prevent the flow direction of the molten PET from being at a perpendicular angle to the surface of the filter. The clean PET melt flows through the filter hole due to pressure, and solid impurities will not directly clog the filter hole and can be discharged to the outside. In this way, the quality and process efficiency of a recycled PET can be effectively improved.

### DESCRIPTION OF THE EMBODIMENTS

Hereinafter, embodiments of the disclosure will be described in detail. However, these embodiments are exemplary, and the disclosure is not limited thereto.

In this specification, a range represented by “one numerical value to another numerical value” is a general representation that avoids listing all the numerical values within the range. Accordingly, the recitation of a particular numerical range covers any numerical value within that numerical range as well as a smaller numerical range defined by any numerical value within that numerical range, as if the above-mentioned any numerical value and smaller numerical range are specified in this specification.

The disclosure provides a recycling method of a polyester material, which includes the following steps. First, the polyester material is subdivided and washed, and then dried using a microwave drying process. Afterwards, the dried polyester material is melted and extruded, and a flow direction of the molten polyester material is at a tangential angle to a surface of a filter for performing melt filtration. Next, the filtered polyester material is cooled and pelletized.

In the embodiment, the polyester material is, for example, a discarded polyester material, which may include but are not limited to a discarded PET bottle, a discarded film product or a discarded textile. The impurity content is less than 3 wt %, and the impurities can include sand, iron, PE, PP, PVC or nylon, etc. In the process of subdividing the polyester material, for example, PET bottles and film products are broken into pieces, and fabrics are cut into shreds. The size of the polyester material after subdivision is, for example, less than 5×5 cm², preferably less than 3×3 cm².

In the embodiment, the microwave drying process is used for drying. The drying temperature of the microwave drying process may be, for example, 30° C. to 125° C., preferably 40° C. to 105° C. The drying time may be, for example, 0.1 minutes to 5 minutes, preferably 0.5 minutes to 3 minutes. The microwave power may be, for example, 1 kw to 100 kw, preferably 2 kw to 50 kw. In addition, after the polyester material is subdivided and washed, the hot air drying process can be used for drying in the pre-process, and then the microwave drying process can be used for drying in the post-process. The drying temperature of the hot air drying process may be, for example, 40° C. to 150° C.° C., preferably 50° C. to 125° C. The drying time may be, for example, 5 minutes to 80 minutes, preferably 10 minutes to 60 minutes. The wind speed may be, for example, 1 m/s to 50 m/s, preferably 2 m/s to 30 m/s. The microwave drying process can effectively control the moisture content. The moisture content of the polyester material after being dried by the microwave drying process may be, for example, less than 1,000 ppm (0.1%), preferably less than 500 ppm (0.05%).

In the embodiment, the dried polyester material is melted and extruded, and the temperature of the melt extrusion may be, for example, 220° C. to 300° C., preferably 210° C. to 290° C.

In the embodiment, the flow direction of the molten polyester material is at the tangential angle to the surface of the filter for performing melt filtration, and filtration is performed using a dynamic filtration mechanism. For example, if a filter moves or rotates, the molten polyester material directly enters the filter; or if the filter is fixed, the molten polyester material enters at a side angle. Both methods can maintain the flow direction of the molten polyester material as being at the tangential angle to the surface of the filter and avoid perpendicular angles. In this way, the clean molten polyester material flows through the filter hole, and solid impurities will not directly clog the filter hole and can be discharged to the outside. The temperature for performing filtration may be, for example, 230° C. to 290° C., preferably 210° C. to 290° C. The tangential speed of the flow of the molten polyester material and the filter hole of the filter may be, for example, 10 m/min to 200 m/min, preferably 15 m/min to 150 m/min. The speed of the flow of the polyester material flowing through the filter hole is 0.1 m/min to 10 m/min, preferably 0.2 m/min to 10 m/min. The pressure for performing filtration may be, for example, 10 bar to 100 bar, preferably 20 bar to 80 bar. The aperture of the filter hole of the filter may be, for example, 10 μm to 100 μm, preferably, 20 μm to 80 μm. For example, mesh weaving or laser drilling is used to achieve such aperture specification requirements. The flow direction of the molten polyester material is at the tangential angle to the surface of the filter. The filter is fixed such that the flow of the polyester material flows from the side, and the flow is in tangential contact with the filter; or the filter adopts a rotating method to bring the flow into tangential contact with the filter to improve the efficiency and quality of melt filtration.

In the embodiment, the filtered polyester material is cooled to a temperature such as 30° C. to 90° C., preferably 40° C. to 80° C. The intrinsic viscosity (IV) of the recycled polyester material is greater than, for example, 0.45 dl/g to 1.30 dl/g, and the decrease in intrinsic viscosity (IV) is less than, for example, 0.06 dl/g.

Hereinafter, the above-mentioned recycling method of the polyester material of the disclosure will be described in detail with reference to experimental examples. However, the following experimental examples are not intended to limit the disclosure.

### EXPERIMENTAL EXAMPLE

### Example 1

After a recycled PET bottle was crushed (<3×3 cm²) and washed, 100.3 kg of PET bottle pieces were taken, wherein IV=0.81 dl/g, moisture content was 4,800 ppm, and impurities such as sand and PP were 0.2%. Drying was performed with hot air at 105° C. and a wind speed of 10 m/s for 15 minutes, and then drying was performed with a 36 kw microwave dryer for 10 minutes. The moisture content of the randomly sampled PET bottle pieces was 210±40 ppm, with an average of 198 ppm. Then, extrusion by an extruder was performed at 250° C. and melt filtration was performed using a rotary filter. The filter hole of the filter was 50 um. The tangential speed of the flow in the filter was 20 m/s. The speed of the flow flowing through the filter hole was 0.8 m/s. The pressure was increased from 50 to 51 bar (50 [symbol] 51 bar). The filtered PET resin was cooled to 60° C. with 25° C. cooling water, and pelletized with a pelletizer. The r-PET resin pellets received were 99.5 kg (yield 99.5%), IV=0.79, and the IV decrease (ΔIV) only decreased by 0.02.

### Example 2 to Example 6

The specifications of feeding materials, drying conditions, and filter conditions were changed respectively, and the rest were the same as Example 1. The test data is as shown in Table 1.

As can be seen from Table 1, microwave drying of the bottle pieces can effectively reduce moisture and improve drying uniformity. Moisture can be effectively controlled to effectively improve the specifications of PET feeding materials. The PET resin flow flows through the surface of the filter in a tangential manner, and the process pressure is stable. The filtration system can improve efficiency and avoid clogging. It can operate stably and maintain a yield of more than 99.0%, thereby achieving quality stability.

TABLE 1

| | | | Example 1 | Example 2 | Example 3 | Example 4 | Example 5 | Example 6 |
|---|---|---|---|---|---|---|---|---|
| Feeding | Weight(kg) | | 100.7 | 100.7 | 101.0 | 101.0 | 101.4 | 101.4 |
| material | PET(kg) | | 100.0 | 100.0 | 100.0 | 100.0 | 100.0 | 100.0 |
| | IV(dl/g) | | 0.81 | 0.81 | 0.62 | 0.62 | 0.93 | 0.93 |
| | Moisture content(kg) | | 0.5 | 0.5 | 0.6 | 0.6 | 0.9 | 0.9 |
| | Impurities(kg) | | 0.2 | 0.2 | 0.4 | 0.4 | 0.5 | 0.5 |
| Drying | Hot air | Temperature(° C.) | 105 | 110 | 110 | — | — | — |
| | | Flow rate(m/s) | 10 | 10 | 15 | — | — | — |
| | | Time(min) | 15 | 20 | 20 | — | — | — |
| | Microwave | Power(kw) | 36 | 36 | 18 | 36 | 18 | 36 |
| | | Time(min) | 15 | 10 | 10 | 30 | 30 | 20 |

| | | | | | | | |
|---|---|---|---|---|---|---|---|
| Moisture content after | Distribution | 210 ± 40 | 324 ± 81 | 450 ± 94 | 94 ± 27 | 150 ± 41 | 115 ± 38 |
| drying(ppm) | Average | 198 | 293 | 401 | 87 | 131 | 97 |

| | | | | | | | |
|---|---|---|---|---|---|---|---|
| Melt | Temperature(° C.) | 250 | 250 | 265 | 265 | 280 | 280 |
| filtration | Pressure(bar) | 50 [symbol] 52 | 60 [symbol] 61 | 70 [symbol] 71 | 80 [symbol] 81 | 60 [symbol] 61 | 50 [symbol] 51 |
| | Filter hole(um) | 50 | 60 | 60 | 70 | 70 | 80 |
| | Tangential speed(m/s) | 20 | 30 | 50 | 80 | 120 | 150 |
| | Filter hole speed(m/s) | 0.83 | 1.70 | 2.4 | 3.8 | 5.7 | 7.1 |

| | | | | | | |
|---|---|---|---|---|---|---|
| r-PET | | | | | | |
| Weight(kg) | 99.4 | 99.6 | 99.5 | 99.7 | 99.5 | 99.8 |
| Yield(%) | 99.4 | 99.6 | 99.5 | 99.7 | 99.5 | 99.8 |
| IV(dl/g) | 0.79 | 0.78 | 0.57 | 0.61 | 0.92 | 0.92 |
| ΔIV (dl/g) | 0.02 | 0.03 | 0.05 | 0.01 | 0.02 | 0.02 |

### Comparative Example 1

After the recycled PET bottle was crushed (<3×3 cm²) and washed, 100.3 kg of PET bottle pieces were taken, wherein IV=0.81 dl/g, moisture content was 0.1% (1000 ppm), impurities such as sand and PP were 0.2%. Drying was performed with hot air at 105° C. and a wind speed of 10 m/s for 30 minutes. The moisture content of the randomly sampled PET bottle pieces was 8,500±4,300 ppm, with an average of 8,310 ppm. Then, extrusion by an extruder was performed at 250° C. and filtration was performed using a fixed filter. The filter hole of the filter was 50 um. The flow was perpendicular to the contact surface of the filter. The speed of the flow flowing through the filter hole was 0.8 m/s. The pressure was 50 to 67 bar. The filtered PET resin was cooled to 60° C. with 25° C. cooling water, and pelletized with a pelletizer. The r-PET resin pellets received were 93.7 kg (yield 93.7%), IV=0.72, and the IV decrease (ΔIV) was as high as 0.09.

### Comparative Example 2 to Comparative Example 6

The specifications of feeding materials, drying conditions, and filter conditions were changed respectively. The rest were the same as Comparative Example 1. The test data is as shown in Table 2. As can be seen from Table 2, the bottle pieces are only dried with hot air. Drying has limitations that affect uniformity, and moisture cannot be effectively controlled, which reduces the specifications of PET feeding materials. The PET resin flow flows in a perpendicular manner through the surface of the filter, and the process pressure continues to increase. The filtration system is easily clogged and cannot operate stably. The yield is less than 97.0%, and the IV decrease (ΔIV) is greater than 0.06, thus reducing quality stability and smoothness of the process.

TABLE 2

| | | | Comparative | Comparative | Comparative | Comparative | Comparative | Comparative |
|---|---|---|---|---|---|---|---|---|
| | | | Example 1 | Example 2 | Example 3 | Example 4 | Example 5 | Example 6 |
| Feeding | Weight(kg) | | 100.7 | 100.7 | 101.0 | 101.0 | 101.4 | 101.4 |
| material | PET(kg) | | 100.0 | 100.0 | 100.0 | 100.0 | 100.0 | 100.0 |
| | IV(dl/g) | | 0.81 | 0.81 | 0.62 | 0.62 | 0.93 | 0.93 |
| | Moisture content(kg) | | 0.5 | 0.5 | 0.6 | 0.6 | 0.9 | 0.9 |
| | Impurities(kg) | | 0.2 | 0.2 | 0.4 | 0.4 | 0.5 | 0.5 |
| Drying | Hot | Temperature(° C.) | 105 | 110 | 110 | 125 | 125 | 125 |
| | air | Flow rate(m/s) | 10 | 15 | 20 | 10 | 15 | 20 |
| | | Time(min) | 30 | 30 | 30 | 30 | 30 | 30 |

| | | | | | | | |
|---|---|---|---|---|---|---|---|
| Moisture content | Distribution | 8,500 ± 4,320 | 7,300 ± 2,310 | 6,500 ± 1,870 | 7,800 ± 4,010 | 6,500 ± 1,690 | 5,640 ± 1,490 |
| after drying(ppm) | Average | 8,310 | 7,097 | 6,430 | 7,097 | 6,420 | 5,375 |

| Melt | Temperature(° C.) | 250 | 250 | 265 | 265 | 280 | 280 |
|---|---|---|---|---|---|---|---|
| filtration | Pressure(bar) | 50 [symbol] 67 | 60 [symbol] 74 | 70 [symbol] 83 | 80 [symbol] 91 | 60 [symbol] 70 | 50 [symbol] 58 |
| | Filter hole(um) | 50 | 60 | 60 | 70 | 70 | 80 |
| | Fluid flow direction | Perpendicular to filter surface | | | | | |
| | Filter hole speed (m/s) | 0.70 | 1.00 | 1.7 | 3.0 | 5.1 | 6.7 |

| | | | | | | |
|---|---|---|---|---|---|---|
| r-PET | | | | | | |
| Weight(kg) | 93.7 | 94.5 | 93.5 | 95.4 | 96.1 | 96.8 |
| Yield(%) | 93.7 | 94.5 | 93.5 | 95.4 | 96.1 | 96.8 |
| IV(dl/g) | 0.72 | 0.72 | 0.54 | 0.55 | 0.83 | 0.82 |
| ΔIV (dl/g) | 0.09 | 0.09 | 0.08 | 0.07 | 0.10 | 0.11 |

To sum up, the disclosure provides the recycling method of the polyester material. The use of a penetrating and targeted microwave drying process can improve the uniformity of drying and allow the moisture to be evenly reduced to the specification requirements, so that there will be no partial parts that are undried. In addition, the recycling method of the polyester material of the disclosure also uses a dynamic melt filtration mechanism to make the PET flow direction contact with the surface of the filter at the tangential angle and prevent the flow direction of the molten PET from being at a perpendicular angle to the surface of the filter. The clean PET melt flows through the filter hole due to pressure, and solid impurities will not directly clog the filter hole and can be discharged to the outside. The disclosure is mainly aimed at effectively controlling the moisture of raw materials (feeding materials) to effectively improve the specifications of PET feeding materials and maintain the stability of the filtration system in the process. The filtration system can improve efficiency and avoid clogging, thereby achieving quality stability, such that smoothness of production line operation can be greatly improved, and energy consumption can be effectively reduced.

What is claimed is:

1. A recycling method of a polyester material, comprising:
drying the polyester material using a microwave drying process after subdividing and washing the polyester material;
performing filtration wherein a flow direction of the molten polyester material is at a tangential angle to a surface of a filter after melting and extruding the dried polyester material; and
cooling and pelletizing the filtered polyester material.

2. The recycling method of the polyester material according to claim 1, wherein after subdividing and washing the polyester material, the polyester material is first dried using a hot air drying process, and then dried using the microwave drying process.

3. The recycling method of the polyester material according to claim 2, wherein a drying temperature of the hot air drying process is 40° C. to 150° C., a drying time is 5 minutes to 80 minutes, and a wind speed is 1 m/s to 50 m/s.

4. The recycling method of the polyester material according to claim 1, wherein a size of the polyester material after subdivision is less than 5×5 cm².

5. The recycling method of the polyester material according to claim 1, wherein a drying temperature of the microwave drying process is 30° C. to 125° C., a drying time is 0.1 minutes to 5 minutes, and a microwave power is 1 kw to 100 kw.

6. The recycling method of the polyester material according to claim 1, wherein a moisture content of the polyester material after being dried by the microwave drying process is less than 1,000 ppm.

7. The recycling method of the polyester material according to claim 1, wherein a temperature for performing melt extrusion is 220° C. to 300° C.

8. The recycling method of the polyester material according to claim 1, wherein a temperature for performing filtration is 230° C. to 290° C.

9. The recycling method of the polyester material according to claim 1, wherein an aperture of a filter hole of the filter is 10 μm to 100 μm.

10. The recycling method of the polyester material according to claim 1, wherein a tangential speed of a flow of the molten polyester material and a filter hole of the filter is 10 m/min to 200 m/min.

11. The recycling method of the polyester material according to claim 1, wherein a pressure for performing filtration is 10 bar to 100 bar.

12. The recycling method of the polyester material according to claim 1, wherein the filtered polyester material is cooled to a temperature of 30° C. to 90° C.

13. The recycling method of the polyester material according to claim 1, wherein an intrinsic viscosity (IV) of the recycled polyester material is 0.45 dl/g to 1.30 dl/g, and a decrease in intrinsic viscosity (IV) is less than 0.06 dl/g.

14. The recycling method of the polyester material according to claim 1, wherein the filter uses mesh weaving or laser drilling.

15. The recycling method of the polyester material according to claim 1, wherein the flow direction of the polyester material is at the tangential angle to the surface of the filter, the filter is fixed such that a flow of the polyester material flows from a side, and the flow of the polyester material is in tangential contact with the filter.

16. The recycling method of the polyester material according to claim 1, wherein the flow direction of the polyester material is at the tangential angle to the surface of the filter, and the filter adopts a rotating method to bring a flow of the polyester material into tangential contact with the filter.

17. The recycling method of the polyester material according to claim 1, wherein a speed of a flow of the polyester material flowing through a filter hole of the filter is 0.1 m/min to 10 m/min.
